(19) United States
(12) Patent Application Publication
(10) Pub. No.: US 2024/0323332 A1
(43) Pub. Date: Sep. 26, 2024

(54) SYSTEM AND METHOD FOR GENERATING AND INTERACTING WITH CONVERSATIONAL THREE-DIMENSIONAL SUBJECTS

(71) Applicant: Looking Glass Factory, Inc., Brooklyn, NY (US)

(72) Inventors: Shawn Michael Frayne, Tampa, FL (US); Oliver Garcia-Borg, Brooklyn, NY (US); Shi Yun Liu, Brooklyn, NY (US); Alexander Duncan, Brooklyn, NY (US); Robert Kodadek, Brooklyn, NY (US); Michelle Senteio, Brooklyn, NY (US); Nitin Bhargava, Brooklyn, NY (US)

(73) Assignee: Looking Glass Factory, Inc., Brooklyn, NY (US)

(21) Appl. No.: 18/610,787

(22) Filed: Mar. 20, 2024

Related U.S. Application Data
(60) Provisional application No. 63/453,369, filed on Mar. 20, 2023.
(60) Provisional application No. 63/465,141, filed on May 9, 2023.

(51) Int. Cl. H04N 13/117; G06T 13/40; G06T 15/00; G10L 15/08; G10L 15/26; H04N 13/305; H04N 13/383

(52) U.S. Cl. CPC H04N 13/117; G06T 13/40; G06T 15/00; H04N 13/305; H04N 13/383; G10L 15/08; G10L 15/26

(57) ABSTRACT

A system can include one or more displays (e.g., lightfield displays, projective displays, stereoscopic displays, autostereoscopic displays, three-dimensional display, etc.), one or more sensors, one or more output devices, one or more computing systems. A method can include optionally generating a three-dimensional subject, receiving an input, determining a response based on the input, and optionally performing the response.

### CROSS-REFERENCE TO RELATED APPLICATIONS

This application claims the benefit of U.S. provisional application No. 63/453,369 filed 20 Mar. 2023 and U.S. provisional application No. 63/465,141 filed 9 May 2023, each of which is incorporated in its entirety by this reference.

### TECHNICAL FIELD

This invention relates generally to the three-dimensional imagery field, and more specifically to a new and useful system and method in the three-dimensional imagery field.

### BRIEF DESCRIPTION OF THE FIGURES

FIG. 1 is a schematic representation of an example of the system.

FIG. 2 is a schematic representation of an example of a three-dimensional subject (e.g., a three-dimensional subject that is being displayed).

FIG. 3 is a schematic representation of an example of a method of interacting with a three-dimensional subject.

FIG. 4 is a schematic representation of an example of a system with a plurality of displays, wherein a three-dimensional subject can interact with information present in one or more displays.

FIG. 5 is a schematic representation of an example of additional inputs that can be used to generate the response(s), in this example using sensors to determine a viewer sentiment (e.g., emotional state) to produce the response.

FIG. 6 is a schematic representation of an example of a three-dimensional subject interacting with one or more viewers in the absence of an input (e.g., in response to an idle period).

FIG. 7 is a schematic representation of an example of a three-dimensional subject interaction modified based on data derived from sensors monitoring an environment or viewer(s) therein.

FIG. 8 is a schematic representation of an example of generating a response where current dialogue is added before existing entries in a record of the conversation.

FIG. 9 is a schematic representation of an example of generating a three-dimensional character and sample dialog for the character based on a speech input from a viewer.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

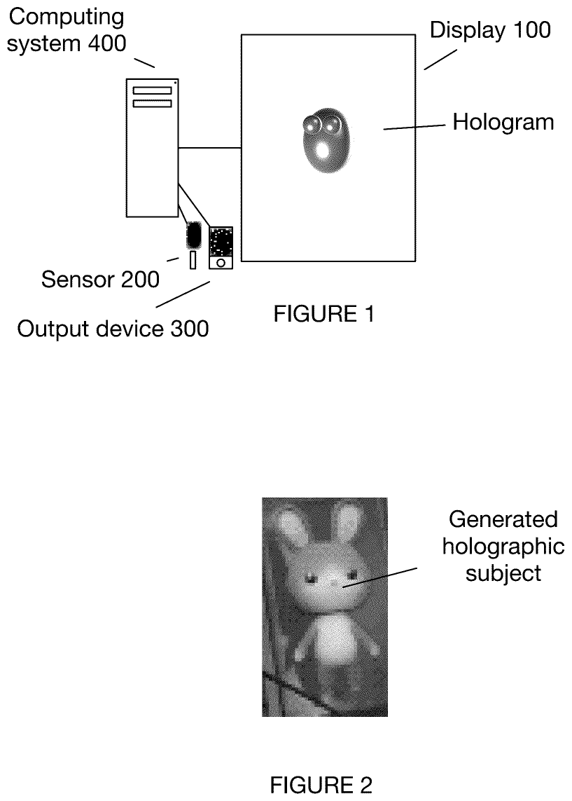

As shown in FIG. 1, the system can include one or more displays, one or more sensors, one or more output devices, one or more computing systems, and/or any suitable components. The display(s) can function to present (e.g., display, output, etc.) a 3D image of a subject (e.g., present a representation of the subject that is perceived or perceivable as three dimensional and/or having depth in one or more direction without relying solely on cues from a single still image). However, the display can otherwise function.

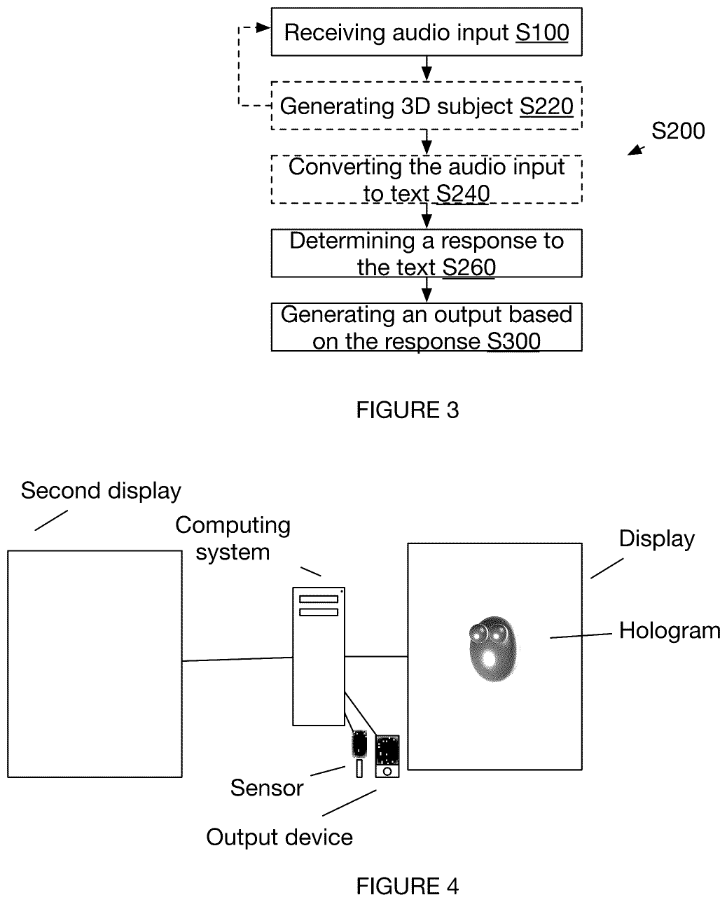

As shown in FIG. 3, the method can include optionally generating a three-dimensional subject, receiving an input, determining a response based on the input, and optionally performing the response. As an illustrative example, a user can interact with a 3D subject (e.g., a hologram) by speaking, where an audio sensor receives (e.g., records) the speech, the speech can be parsed (e.g., by converting the speech to text to be fed into a language model) to generate a response (e.g., an output from the language model), and the 3D subject can perform the response(s) (e.g., perform an action based on the speech, generate additional 3D subject(s) based on the response, speak such as by outputting audio from a speaker and optionally moving its mouth in time with the output audio, form expressions or otherwise use body language to respond to the input, etc.). Note that while the term user may be used herein, user is not limited to a human user but can also include artificial users (e.g., artificial intelligence—for instance two artificial intelligence bots can interact with each other in an open or closed loop). Similarly, the 3D subject is not limited to operating as a chatbot or artificial intelligence (e.g., a remote operator can operate or act as the 3D subject and/or provide responses such as by using the 3D subject as an avatar).

### 2. Benefits.

Variations of the technology can confer several benefits and/or advantages.

First, the inventors have discovered a cross-platform three-dimensional chatbot (e.g., 3D subject, hologram, holographic subject, light field subject, light field object, three dimensional object, etc.) you can interact with (e.g., where the three-dimensional chatbot can perform verbal, physical, etc. responses; can create three-dimensional creations based on, during, etc. the conversation; etc.). In a first variant, the three-dimensional chatbot can be generated using WebXR (or another API) and can be shared over the internet on various devices (e.g., in a manner as described in U.S. patent application Ser. No. 18/117,834, titled “SYSTEM AND METHOD FOR PRESENTING THREE-DIMENSIONAL CONTENT” filed 6 Mar. 2023 which is incorporated in its entirety by this reference). In a second variant, the three dimensional chatbot can be generated using an executable (e.g., a program, a Unity extension, etc.) where the chatbot (e.g., chatbot responses) can be generated and/or shared locally or ‘on premise’ (e.g., with speech to text, text to speech, language mode hosting, etc. being on a local computing system). The first and second variant can be combined (e.g., chatbot can be generated locally and shared over the internet, executable can be accessed over the internet, etc.) and/or the chatbot can be accessed and/or generated in any manner.

Second, variants of the technology can improve a conversation flow and/or perception of a continuous conversation with a three-dimensional chatbot. For instance, by parsing a response (e.g., an output from a language model) into fragments (e.g., phrases, sentences, paragraphs, etc.), the three-dimensional chatbot can initiate part of a response without needing a full response to be generated (e.g., begin providing the response while the rest of the response is formed). Additionally, or alternatively, the three-dimensional chatbot can include an initial or temporary response (e.g., based on a conversation topic, based on a personality of the chatbot, based on a viewer mood, etc.), can draw out sounds (e.g., vocalize the word ‘well’ as ‘wellllllllllllll’), use filler words (e.g., ‘uh,’ ‘um,’ ‘huh,’ etc.), generate expressions (e.g., a thoughtful expression, a thought bubble, etc.), use nonverbal cues (e.g., appear to have a distant gaze, indicate that a moment of thought is needed, etc.), and/or can other provide an initial response while the response to the input is generated.

Third, variants of the technology can produce more realistic conversational effects based on sensor readings (e.g., based on sensors proximal the display, based on sensors in an environment of interest to the viewer, etc.). In these variants, the sensor readings can be provided to the language model used to generate the response (e.g., by generating a text input from the sensor readings), where the language model can then leverage the sensor readings in addition to or in the alternative to other inputs to generate the response.

Fourth, variants of the technology can selectively censor and/or handle sensitive (e.g., confidential, private, distressing, etc.) information. In these variants, the information can be identified in either or both of the input (e.g., by analyzing the generated text, by analyzing the audio) and/or the output (e.g., by analyzing the response). In some variations, the language model can also include a sensitive information analysis providing additional or alternative detection and/or handling for the sensitive information. In these variants, when sensitive information is identified, the response can depend on the sensitive information (e.g., deflect the conversation to another topic, provide emotional support without directly addressing the sensitive information, confirming that the user wants to continue discussing sensitive information, explicitly stating that the information is sensitive and cannot be discussed, etc.). For instance, a three-dimensional chatbot operating in a children's hospital may deflect a conversation about death or loss to telling a story.

Fifth, variants of the technology can enable the three-dimensional chatbot to be taught new information without a training period. For example, the three-dimensional chatbot can be placed in a special mode (e.g., an information update mode, an administrative mode, a training mode, etc.) where new information can be provided to the chatbot to change the responses and where the new information can then be provided when the chatbot operates in its default mode (e.g., normal mode, conversation mode, etc.). As an illustrative example of the use of such a mode, the chatbot can be placed in the mode to be taught that information it usually provides is incorrect (e.g., update information pertaining to a nearest bathroom location when one bathroom is out of order).

Sixth, variants of the technology can enhance the perception of and/or flow of conversation between holograms and viewers. In one example, the inventors found that providing user dialogue as the most recent input to a language model for generating a response can result in fact-spewing and/or know-it-all natured chatbot. One way the inventors found to overcome this issue was to introduce the user dialogue (or an encoding thereof such as a text encoding, retrieval augmented generation (RAG) encoding, multidimensional encoding, etc. such as a question posed by the viewer) as the earliest (or to other points in the history of the conversation) rather than as the latest information added to the conversation. In such variants, the chatbot is perceived as more conversational (e.g., more comfortable, effortless, smooth conversation). In another variant, the inventors found that a plurality of agents (e.g., an agent that generates a factual response and a subsequent agent that modifies the response based on a personality, conversational traits, etc.) can be used to improve the conversational capabilities of the chatbot (e.g., for speech-based conversation). These variations have the potential to help decrease an occurrence of ‘hallucinations’ from the language model (although ‘hallucinations’ may be more acceptable to viewers as this is implemented as a conversation rather than as definitive fact generation typically).

Seventh, the inventors have found that by leveraging a combination of image-from text models, language models, and optionally audio models; viewers can generate and/or modify (e.g., change) their own personal holograms (e.g., to suit their current whims, target audience, desired conversation partner, etc.).

However, variants of the technology can confer any other suitable benefits and/or advantages.

### 3. System.

As shown in FIG. 1, the system can include one or more displays 100, one or more sensors 200, one or more output devices 300, one or more computing systems 400, and/or any suitable components. The display(s) can function to present (e.g., display, output, etc.) a 3D image of a subject (e.g., present a representation of the subject that is perceived or perceivable as three dimensional and/or having depth in one or more direction without relying solely on cues from a single still image). However, the display can otherwise function.

The display(s) preferably function to display the 3D subject (e.g., hologram) as a three-dimensional image (e.g., as an image that can be perceived as three dimensional). The display can additionally or alternatively display two-dimensional content (e.g., concurrently with displaying 3D content), display the three-dimensional content in 2D, and/or can otherwise function. The display can be a multi-viewer display (e.g., a display that enables two or more viewers to perceive content as three dimensional at the same time), a single-viewer display (e.g., a display that enables a single viewer to perceive content as three-dimensional at a time), and/or can be any suitable display. Exemplary displays include: computer monitors, tablets, laptops, smart phones, extended reality (XR) devices (e.g., augmented reality (AR) devices, mixed reality (MR) devices, virtual reality (VR) devices, etc.), virtual reality headsets (e.g., Oculus, HTC Vive, Valve, Sony PlayStation VR, Apple Vision Pro, etc.), projection displays (e.g., projectors), augmented reality headsets (e.g., smart glasses, Microsoft HoloLens, Heads Up Displays, handheld AR, holographic display, etc.), superstereoscopic display (e.g., a display as disclosed in U.S. patent application Ser. No. 17/328,076 filed 24 May 2021 titled ‘SUPERSTEREOSCOPIC DISPLAY WITH ENHANCED OFF-ANGLE SEPARATION’, U.S. patent application Ser. No. 17/332,479 filed 27 May 2021 titled ‘SYSTEM AND METHOD FOR HOLOGRAPHIC DISPLAYS’, and/or U.S. patent application Ser. No. 17/326,857 filed 21 May 2021 titled ‘SYSTEM AND METHOD FOR HOLOGRAPHIC IMAGE DISPLAY’, each of which is incorporated in its entirety by this reference; etc.), autostereoscopic displays, multi-view display, 2D-plus-depth display, tracked displays (e.g., as disclosed for example in U.S. patent application Ser. No. 17/877,757 titled ‘SYSTEM AND METHOD FOR HOLOGRAPHIC DISPLAYS’ filed 29 Jul. 2022, which is incorporated in its entirety by this reference), multi-viewer displays (e.g., 3D displays where images can be perceived as 3D by more than one viewer simultaneously), single-viewer displays (e.g., 3D displays where only a single viewer can perceive an image or subject thereof as 3D but where potentially other viewers can perceive a 2D image), 3D television (e.g., active shutter system, polarized 3D system, three-dimensional displays (e.g., Sony Spatial Reality Display, Lume Pad, etc.), and/or any suitable display(s) can be used.

In some variants (as shown for instance in FIG. 4), a plurality of displays can be used. In these variants, displays of the plurality of displays can be the same or different. In a first specific example, a system can include a 2D display and a 3D display. In this example, the 3D display can be configured to present the three-dimensional subject and the 2D display can be used to present information related to the conversation, to the environment the displays are located in, information derived from sensor readings, a three-dimensional subject (e.g., from a single perspective, with effects to produce a perception of depth, etc.), and/or any suitable information. An exemplary instance of this example could be a three-dimensional subject that provides directions within a public transportation hub. The three-dimensional subject could be visible on a 3D display and could pull up directions or instructions (e.g., a map, timetables, etc.) on a 2D display (or a 3D display, topographic display, model, etc.). In a second specific example, the system can include two or more three dimensional displays. In the second specific example, each display can be configured to display a three-dimensional subject (e.g., the same or different three-dimensional subject), where each three-dimensional subject can interact with each other (e.g., hold conversations together) and/or with users (e.g., viewers) proximal the displays. An exemplary instance of the second specific example could be in an office, retail, business, and/or other employment setting where each display can present a three-dimensional subject that can talk to each other mimicking office interactions (e.g., to make an office feel full, making jokes to help make customers or patients feel at ease, etc.). However, any suitable display(s) can be used in any suitable manner. Within these examples (and more broadly variants that include a plurality of displays), the holographic character is preferably generated in a manner that can be presented to each display and rendered in (up to, but not necessarily always meeting) the greatest richness that the display can achieve (e.g., using techniques such as those described in U.S. patent application Ser. No. 18/117,834 titled ‘SYSTEM AND METHOD FOR PRESENTING THREE-DIMENSIONAL CONTENT’ filed 6 Mar. 2023 which is incorporated in its entirety by this reference). However, additionally or alternatively, the system and/or method can generate a plurality of formats (e.g., a separate format for each display).

The sensor(s) preferably function to receive one or more input from user(s), where the input can be used in generating a response from the 3D subject. The sensor(s) can be collocated with the display (e.g., collocated with the 3D subject) and/or remote from the 3D subject (e.g., outdoors, in a different room, in a different building, etc.). Exemplary sensors include audio sensors (e.g., microphones), light sensors, tracking sensors (e.g., eye tracker, gaze trackers, face tracker, etc.), proximity sensors (e.g., Bluetooth beacons, capacitive sensors, optical sensor, etc.), haptic sensors, optical sensors (e.g., camera, IR camera, etc.), depth sensors (e.g., depth cameras, stereo cameras, time-of-flight camera, LIDAR, RADAR, SONAR, etc.), environment sensors (e.g., thermometers, barometers, hygrometers, anemometers, rain sensors, etc.), person counters, force sensors (e.g., scales), and/or any suitable sensors can be used. In some variants, the system can include a plurality of sensor(s), for instance to record stereo sound inputs from

The output device preferably functions to output one or more response (e.g., generated based on the input(s)). Exemplary outputs include audio output (e.g., from a speaker), lighting (e.g., from a light source, set of light sources, etc.), light intensity (e.g., from a light source or set of light sources), vibration or other haptic feedback (e.g., via a transducer), and/or any suitable output and/or output devices can be used. Exemplary output devices include: speakers (e.g., smart speakers, phased speakers, mono speakers, stereo speakers, etc.), light fixtures, transducers, thermostats, (de)humidifiers, displays (e.g., 2D display, 3D display, etc.), appliances, security systems, and/or any suitable output device(s).

The computing system can function to receive input(s) (e.g., from the sensor(s)), parse the input(s), generate response(s) based on the input(s), update the 3D subject (e.g., based on the input(s), based on the response, etc.), transmit (and format to be output) the response to an output device, transmit (e.g., share) the 3D subject (and optionally response) with other users, and/or can otherwise function. The computing system is preferably local to the display(s). However, the computing system can be remote from the display(s) (e.g., cloud computing, server, etc.) and/or distributed in any manner (e.g., perform a set of operations locally and a second set of operations remotely). The computing system is preferably internet connected, but can be disconnected (e.g., offline). The computing system is preferably configured to perform speech recognition (optionally with user-specific recognition such as based on voice frequency, word choice, face recognition, emotion recognition, etc.) and run or leverage a large language model (e.g., GPT, BERT, XLNet, Megatron-Turing NLG, Ernie 3.0 Titan, Claude, GLaM, Gopher, LaMDA, Chincilla, PaLM, OPT, YaLM, Minerva, BLOOM, Galactica, Alexa™, Neuro-sama, LLAMA, Cerebras, Falcon, BloombergGPT, PanGu-2, OpenAssistant, Jurassic, Mistral, Grok, Gemini, Mixtral, Phi, Eagle, etc.). However, the computing system can otherwise be configured (e.g., can use nongenerative speech services such as Alexa, translation bots, etc.; can lenticularized an image; can form a three-dimensional character such as in a manner as disclosed in U.S. patent application Ser. No. 18/117,834, titled “SYSTEM AND METHOD FOR PRESENTING THREE-DIMENSIONAL CONTENT” filed 6 Mar. 2023 which is incorporated in its entirety by this reference; etc.). In some variants, the computing system can additionally or alternatively leverage a voice model (e.g., MusicLM, MusicGEN, Voicebox, tortoise text-to-speech, VoiceLab, PlayHT, AI voices, stitched voices, etc.) to generate a voice and/or modify a voice to reflect auditory attributes (e.g., emotional intonation, intentions, personality, speech pattern, sociolect, vocal register, vocal range or frequency, dialect, accent, pitch, speed, duration, loudness, timbre, phonetic elements, acoustic elements, prosody, flow, etc.) such as to imitate a person, generate a customized auditory attribute, and/or for other purposes; a generative image model (e.g., DALL-E, CLIP, CM3leon, Stable Diffusion, Midhourney, Imagen, Parti, Firefly, VQGAN+CLIP, variational autoencoders (VAEs), generative adversarial networks (GANs), diffusion models, etc.) can be used to generate a 3D subject (e.g., as a plurality of views or distinct images of the subject from different perspectives, as a 3D model, as a Nerf, as a Gaussian, as a Human Gaussian Splat (HuGS), as a tensor, in a representation as described in U.S. patent application Ser. No. 18/117,834 titled ‘SYSTEM AND METHOD FOR PRESENTING THREE-DIMENSIONAL CONTENT’ filed 6 Mar. 2023 which is incorporated in its entirety by this reference, etc.), and/or other suitable model(s) (e.g., code generative models for a chatbot that can assist with a coding project, teach computer coding, etc.; video generative models for generating temporally-coherent actions in the 3D subject; planning models such as to enable a chatbot to assist with scheduling, organizing, planning, etc.; etc.). The computing system can include one or more: graphic processing units (GPUs), central processing units (CPUs), tensor processing units (TPUs), microprocessors, and/or any other suitable processor(s).

In some variants, the system can be configured to operate in a plurality of modes. For instance, the system can be configured to operate in an autonomous mode (e.g., where the conversation is between one or more users and chatbots, between two or more chatbots, etc.) and a manual mode (e.g., where at least one chatbot is replaced by a human operated). In another example, the system can operate in stylized mode and a photorealistic mode, where in the photorealistic mode the 3D image (subject thereof) can be generated using high-quality 3D images of a person (e.g., a photorealistic model of a person, a hyper realistic model of a person, etc.) and in the stylized mode the 3D image (subject thereof) can be generated taking artistic liberties (e.g., characters, human models, etc. with less focus on photorealism such as a character shown in FIG. 2). Additional or alternative modes could include tracked modes and/or untracked modes (e.g., as described in U.S. patent application Ser. No. 18/225,603 titled ‘SYSTEM AND METHOD FOR HOLOGRAPHIC IMAGE DISPLAY’ filed 24 Jul. 2023 which is incorporated in its entirety by this reference), generative mode (e.g., where the system generates, modifies, tweaks, varies, etc. the 3D image or subjects), a receptive mode (e.g., a mode wherein the 3D subject is receptive to inclusion of new information, to update knowledge of the 3D subject, etc.), an educator mode (e.g., wherein the 3D subject provides pedagogical feedback to a user, updating a user provided information that can be but is not necessarily a direct input, educating the user to understand the changes, etc.), a silent companion mode (e.g., where the 3D subject is present and updates expressions, body language, etc. without speaking or providing audio output), a story-telling mode (e.g., where the chat bot tells a story without expecting viewer input, where the chatbot modifies a story based on a viewer input throughout the story, etc.), default mode (e.g., where the system uses a default 3D image or subject, a receptive mode, a reactive mode such as reacting to sensor data, etc.), and/or any suitable mode(s). These variants can be particularly beneficial for applications leveraging automated support but where the automated support was insufficient and necessitated human interaction, for applications of supporting company or companionship where when a human is not available a chatbot can provide companionship and can be replaced with a human when available, and/or for other suitable applications (e.g., brainstorming sessions). The system preferably seamlessly transitions between modes. For instance, the system could transition from a character mode to a human mode by transitioning through a photorealistic depiction of the human replacing the character before transferring into a video feed (e.g., video conference) style with the human replacing the character. As another example, a voice model can be used to generate an intermediate voice to make a seamless transition from a character voice to a human voice. As another example, a character model can be modified to be more (or less) expressive and/or have more “human-like” expressions before transitioning a character to a human. However, the transition can be abrupt (e.g., rapid change in image, voice, etc.) and/or can have any suitable qualities or characteristics.

In some embodiments, the system can be integrated into an external system. For example, the system (e.g., a display thereof) can be mounted to a face or head region of a robot allowing a robot to act as a chatbot (and/or be converted to enabling interfacing with a human depending on an operation mode). Other (non-limiting) external systems that the system can be integrated into or interface with include vehicles, telephones (and/or phone booths), computers, windows, and/or marketing displays.

### 4. Method.

As shown for example in FIG. 3, the method can include optionally receiving an input, determining a response (e.g., based on the input), and optionally performing the response. The method preferably functions to facilitate (e.g., aid, enable, etc.) an interaction (e.g., conversation) between a user and a 3D subject (where the 3D subject is generally computer generated and/or controlled).

The 3D subject (e.g., holographic subject, 3D image, 3D character, 3D avatar, etc.) can be represented as a neural radiance field (e.g., NeRF), from volumetric capture, 3D models (e.g., mesh based models, polygon models, etc.), using a plurality of images (e.g., a photoset, a quilt image, etc.), as a Gaussian splat (e.g., Human Gaussian Splat), and/or in any suitable representation (e.g., a quilt image, depth image, and/or other representations such as disclosed in U.S. patent application Ser. No. 18/117,834, titled “SYSTEM AND METHOD FOR PRESENTING THREE-DIMENSIONAL CONTENT” filed 6 Mar. 2023 and/or U.S. patent application Ser. No. 18/137,720 titled ‘SYSTEM AND METHOD FOR GENERATING LIGHT FIELD IMAGES’ filed 21 Apr. 2023, each of which is incorporated in its entirety by this reference). As a first illustrative example, a 3D scan (e.g., a volumetric scan, NeRF scan, etc.) of a person, user, animal, plant, and/or other object can be rigged (e.g., with blend shapes added based on global parameters) to generate 3D subject(s). Variations of the first illustrative example can include the import of a single image of a person, scene, or object and the 3D generation of that object (e.g., using machine learning techniques). As a second illustrative example, a 3D subject can be a corporate or brand mascot that has been converted into a three-dimensional character (e.g., using a generative algorithm to create a plurality of perspectives of the mascot, by forming a caricature of the mascot, using a 3D image or 3D video generative model, etc.).

The 3D subject can optionally be associated with a personality (e.g., a unique personality; a personality of or based on an existing character or person; a blend of personalities or personality traits; a set of preferences such as preferred name, preferred foods, topics of conversation, etc.; etc.). The personality can be user selected (e.g., user generated), derived from the three-dimensional subject (e.g., based on cultural assumptions about a subject or character such as a rabbit that likes carrots), be generated at the same time as the three-dimensional subject (e.g., the generative model, and/or can otherwise be determined. In variants, the personality can be fluid and change (e.g., based on the conversation, based on a user selection such as to change who they are conversing with, etc.). As an illustrative example, a user input could include a phrase such as “ . . . like my grandmother” to have a response (and/or three-dimensional subject appearance) change to a form similar to a grandmother (e.g., protective, indulgent, solicitous, etc. response or manner of providing the response such as tone, inflection, word choice, pitch, volume, etc.). In this example, later in the conversation the user could suggest changing the character using another phrase such as “now I'd like to speak to a famous politician” and the characters responses could modify to similar to an older female politician (to maintain a semblance to the grandmotherly features) and/or could switch entirely into speech patterns evocative of famous politicians or orators.

The 3D subject can optionally include one or more accessories. Examples of accessories include hats, clothes, jewelry, backgrounds, interaction objects, and/or any suitable accessories can be envisioned. The accessories can be pre-made (e.g., 2D models, 3D models, other assets, etc.), generated on the fly or on request (e.g., by a generative AI process or image generative model such as DALL-E, Midjourney, Imagen, Stable Diffusion, DeepDream, etc.), and/or can otherwise be generated. For example, a user could say “Are you hungry? Make something sweet for my friend”, and an image or a three-dimensional model of food might be generated in the scene or near the subject (e.g., based on the 3D subject's such as matching preferences or personality of the 3D subject). For example, an accessory of the 3D subject can change based on a conversational input (e.g., generating or removing the accessory based on what a user says), sensor data (e.g., the 3D subject can change clothing, accessories, etc. based on a weather proximal the user, a weather location selected by the user, a user friend or family member location, etc.), and/or can otherwise be changed.

In some embodiments, the 3D subject can be operable in one or modes of operation. Typically, the 3D subject operates in a conversant mode (e.g., generating and performing responses to a conversation with one or more users). However, the 3D subject can additionally or alternatively be operated in other modes. Exemplary modes can include: a receptive mode (e.g., a mode wherein the 3D subject is receptive to inclusion of new information, to update knowledge of the 3D subject, etc.), an educator mode (e.g., wherein the 3D subject provides pedagogical feedback to a user, updating a user provided information that can be but is not necessarily a direct input, educating the user to understand the changes, etc.), a silent companion mode (e.g., where the 3D subject is present and updates expressions, body language, etc. without speaking or providing audio output), a story-telling mode, and/or in any suitable modes. The modes can be switched automatically (e.g., based on a sensor reading such as a sensor indicating that a room is occupied, a device is out-of-order, etc.), based on an administrator input, based on an input (e.g., a request for a story, potentially sensitive topics in the input(s) or response(s), etc.), user preference, time (e.g., time of day), 3D subject personality (e.g., a grandfatherly personality could be predisposed to switch to a story telling or rambling mode), and/or based on any suitable criteria.

The method and/or steps thereof are typically performed iteratively to mimic a conversational flow. However, the method and/or steps thereof can be performed once (e.g., to act as a greeting or closing, perform phatic functionality, etc.) and/or with any suitable timing. In some variants, an activation word or term and/or sensor measurement (e.g., measuring proximity of the viewer(s) to the 3D subject) can be used to initiate the method and/or steps thereof.

The method and/or steps thereof can be performed automatically (e.g., a response can be generated whenever a user is detected talking to the 3D subject, based on a sensor input, etc.), at predetermined times (e.g., when a user is detected proximal the 3D subject or display for a threshold amount of time), at a predetermined frequency, or randomly.

Receiving an input S100 can function to receive a user provided input. The inputs are generally received from one or more sensors, where the sensor readings or data are received at the computing system (e.g., local computing system, remote computing system). However, the inputs can additionally or alternatively be received from a database, a user input device, and/or any suitable input source. Examples of inputs include: audio input, images (e.g., acquired using an image sensor, camera, camera array, lightfield camera, etc.), haptic inputs, light sensors (e.g., color sensors, intensity sensors, light direction, etc.), tracking data (e.g., eye position, gaze, etc.), facial recognition, weather (e.g., temperature, humidity, precipitation, degree of sunshine, time of day, pressure, etc.), location, number of users, user sentiment (e.g., emotional state), and/or any suitable inputs can be used. In some variants, an input could additionally or alternatively include a time (e.g., time since last response, time since last response, time since a user came within a threshold distance of the 3D subject, etc.).

Receiving an input can include parsing the input, where parsing the input(s) can function to convert the input(s) to a format that can be processed by the model(s). For example, a sensor data (e.g., an audio input such as speech or conversation, images, videos, temperature readings, weather, etc.) can be converted to text (e.g., speech-to-text conversion). The input(s) can be parsed using a translator, using speech recognition (e.g., acoustic modeling; language modeling; attention model; hidden Markov model; dynamic time warping-based speech recognition; machine learning such as neural networks, recurrent neural networks, time delay neural networks, transformers, feedforward neural networks, etc.; etc.), phoneme recognition, word recognition, phrase recognition, sentence recognition, data labeling (e.g., using artificial intelligence, human-in-the-loop process, etc.), and/or using any suitable input parsing mechanism.

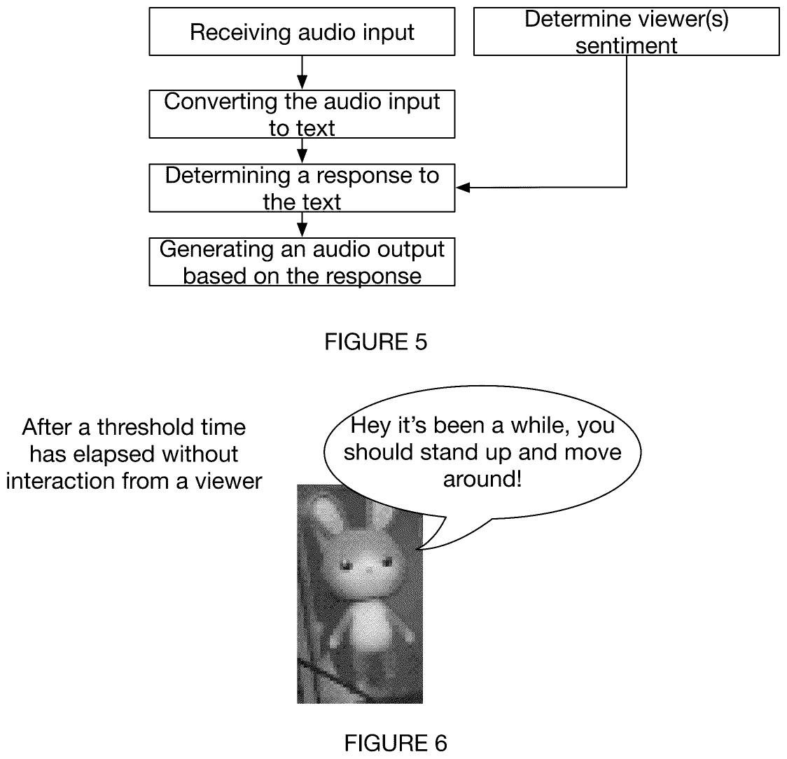

In some variants (as shown for instance in FIG. 5), parsing an input can include determining a user sentiment (e.g., emotional state) and/or physiological state such as based on word choice, tone, body language, facial expression, user provided information, physiological sensor (e.g., blood pressure monitor, respiration monitor, etc.), and/or in any manner.

In some variants, receiving an input can include filtering the input such as to detect a potentially sensitive topic (e.g., upsetting, inappropriate such as for an age of a user, dangerous, classified, personal, private, obscene, etc.). In these variants, the input is preferably filtered using a filter or model that is separate from (e.g., resides before) a language model used to determine a response, which can provide a technical advantage of an independent check for a potentially sensitive topic. However, the input could additionally or alternatively be filtered using a filter integrated in the language model and/or in any suitable manner.

Determining a response S200 can function to generate a response such as a response based on the input(s). The response can be determined using a ruleset (e.g., a set of rules indicating a response to be selected based on an input), using artificial intelligence (e.g., generative artificial intelligence, using nongenerative artificial intelligence, etc.), and/or in any manner.

Inputs to S200 can include an audio input, a text input (e.g., transcript from the audio input), 3D subject characteristics (e.g., personality, age, etc.), document library, and/or other suitable inputs can be used. In some variants, the inputs can be converted into an encoded format, where the encoding format can be matched to an encoding format for a document library and/or historical conversation. As an example, the input can be encoded as a vector to facilitate retrieval of similar information from the documents (e.g., using documents with vectors closest in Euclidean norm to the input).

For example, an audio input (converted to text) can be fed into a language model (e.g., a large language model, a generative chatbot, etc.), where the output from the language model can be used as the response. In variants, only the most recent audio input, a historical record of the conversation (e.g., with both historic user inputs and historic user responses to those inputs in an interspersed order), a running record of the conversation (e.g., up to a limit for amount of information that can be provided to the model), and/or any suitable information can be provided to the language model. However, the response can be generated in any manner.

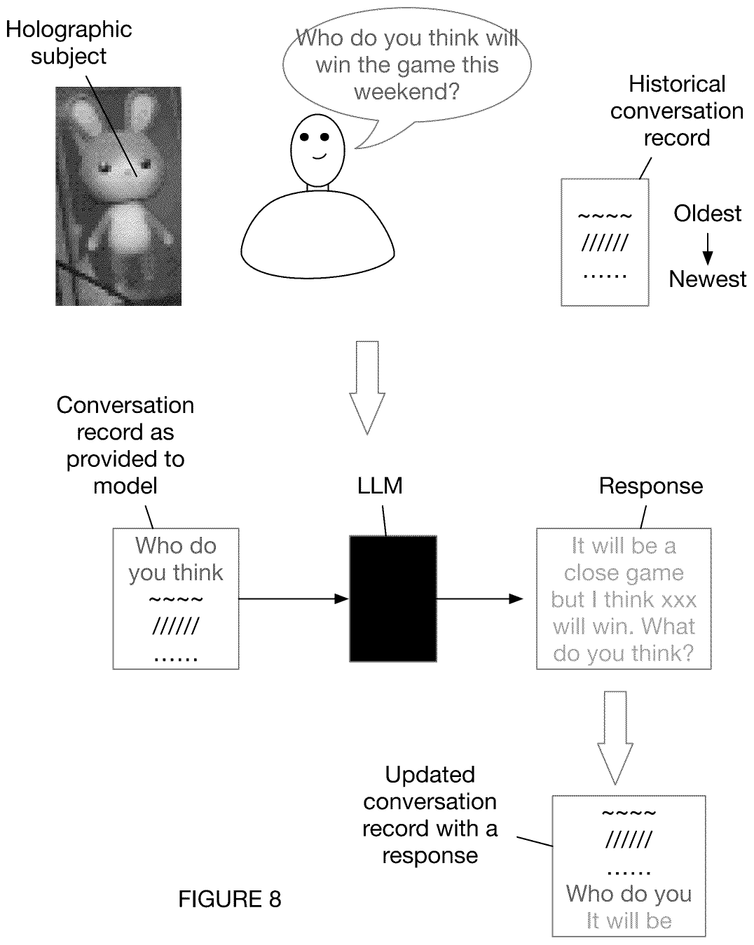

In a variant (as shown for example in FIG. 8), the most recent audio input can be provided at the earliest position in the historic conversation record. This variant can be beneficial for avoiding a perception of the chatbot as merely a fact-spewing character but rather results in a chatbot that feels like a conversational partner. However, the most recent audio input (to which a current response is being generated) can be added to any suitable position within the historic conversation record (e.g., at the end, in the middle, etc.). After the response is generated, the most recent audio input is preferably removed from the earliest position in the historical record (e.g., moved to the correct time ordering, moved to a latest position, etc.). However, additionally or alternative, the historical record can be built up backwards such that each new entry (audio input or response output) is effectively at the “earliest” point in the conversation; reorganized to separate inputs and outputs (e.g., responses) such that the record includes only one of the inputs or the outputs, reorganized such that inputs are grouped and responses are grouped, and/or otherwise regrouped; and/or can otherwise be built or contain entries.

In a related variant (e.g., that can be used in combination with the preceding variant), the response can be generated using a plurality of models. For instance, a first ‘factual model’ can generate a factual response to a query or user input where a second ‘conversational model’ can convert the factual response into a more conversant form.

The response can be user-specific (e.g., specific responses to specific individuals such as based on voice recognition, gaze recognition, image recognition, conversation, etc. such as to address specific users, tailor the response based on user preferences, etc.) and/or user-generic (e.g., be agnostic to user, be agnostic to input source, etc.).

In some variants, generating the response can include accessing (e.g., retrieving) one or more documents where the documents can be used to generate the response. For example, retrieval-augmentation generation (RAG) can be used to facilitate document retrieval and/or response generation. However, other methods can be used.

The response is typically provided (e.g., generated) in a text format. However, additionally or alternatively, the response can be (e.g., include, produce, generate, determine, etc.) images (e.g., still images, frames of a video, for instance in S220, etc.), objects (e.g., 2D models, 3D models, etc.), sounds (e.g., speech-to-speech), code (e.g., source code, machine code, etc.), and/or any suitable information. In some variations, a response can include a plurality of components. For instance, a response could include a first component associated with speech for the 3D subject and a second component associated with an image to be projected (e.g., contemporaneously with the 3D subject speaking, before the 3D subject speaks, after the 3D subject speaks, once the 3D subject says a trigger phrase, etc.). In examples of this variation, the response can be provided as text where the text can be parsed to identify the first component and the second component (e.g., based on context, based on key words, using machine learning trained to separate the components, etc.). However, the components can otherwise be identified and/or provided.

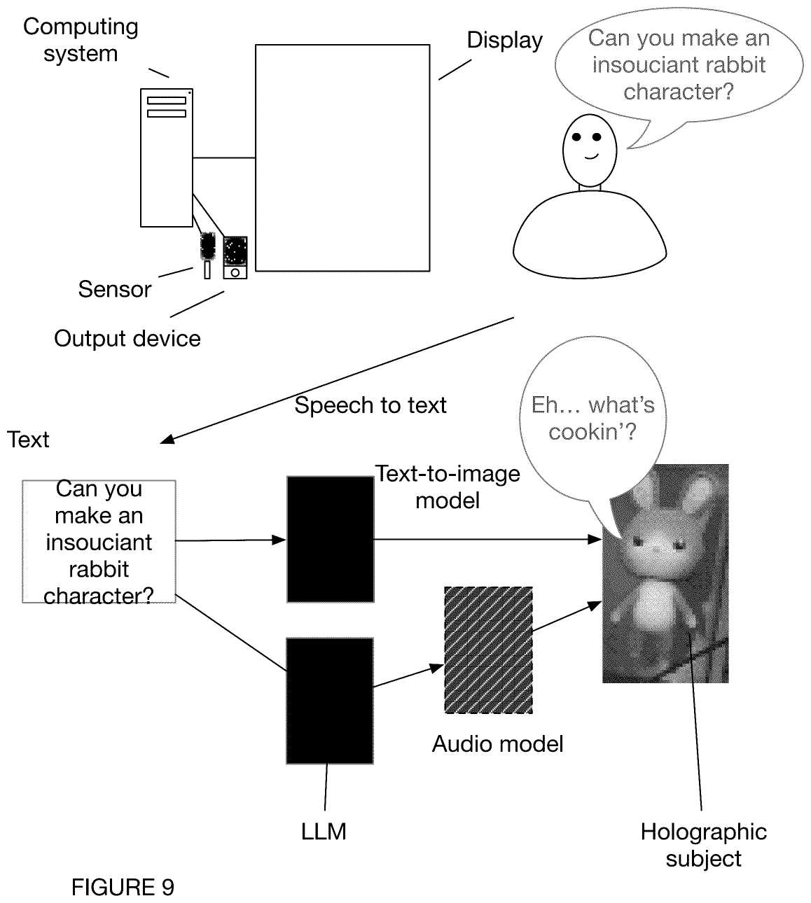

In some variants, determining a response can include generating a three-dimensional subject (e.g., in S220). For example (as shown for instance in FIG. 9), a 3D subject (and optionally associated personality) can be generated based an audio or text input (e.g., “I'd like to chat with a 40-something year old professorial dinosaur on the beach, with the personality of Hans Solo” would lead to a dinosaur 3D subject character with mannerisms reminiscent of Hans Solo character). For example, generating a three-dimensional subject can include receiving a voice request, converting the voice request to text, providing the text to a generative image model (e.g., DALL-E, Midjourney, Imagen, Stable Diffusion, DeepDream, image generation models, etc.) to generate one or more images of the three-dimensional subject, optionally (e.g., when working from a single image of the three-dimensional subject) generating a plurality of images of the three-dimensional subject from a plurality of views (e.g., using machine learning, interpolation between existing images, extrapolation from existing images, etc.), and optionally importing the generated three-dimensional subject into a 3D scene (e.g., applying rigging and blend shapes for animation purposes) to immerse the three-dimensional subject in a scene. However, the three-dimensional subject can otherwise be generated.

In some variants, determining the response or generating the three-dimensional subject can include altering the three-dimensional subject. For instance, the three-dimensional subject can be altered (e.g., applying stylistic alterations) based on the three-dimensional subject personality, three-dimensional subject's creator, based on the user, and/or in any manner. As an illustrative example, the background of a Miyazaki character like Mei can be of a hand illustrated and animated style of the film Totoro, based on either hard-coding or an on-the-fly generated request from the user chatting with the Miyazaki character (e.g., three-dimensional subject). The stylistic alterations can be determined (e.g., generated), for instance, through connection to a generative art service (e.g., Midjourney, DALL-E, Imagen, Stable Diffusion, DeepDream, etc.).

However, the three-dimensional subject can be pregenerated (e.g., a user can select an existing hologram, 3D subject, etc. to interact with), can be automatically generated (e.g., generated without requiring an input such as an audio input), and/or can otherwise be generated.

In some variants, determining a response can include sending an image (e.g., a photo) and/or a 3D image (e.g., hologram, lightfield image, etc.) to another user or endpoint, announcing that messages and/or images (2D images, 3D images, etc.) have been received, searching for information (and/or files or documents) on the internet and/or the computing system.

In some variants, determining a response can include changing the environment proximal the display based on context (e.g., turn on the lights in a room on specific request, or based on the context of the conversation, toggling on an ultrasonic tactile feedback panel for touch interactions, etc.).

In some variants, determining a response can include changes to the three-dimensional subject (e.g., a background of the three-dimensional subject, clothes or accessories of the three-dimensional subject, etc. can be changed based on inputs generated using elements like a fish-eye camera spatial microphones, 3D cameras like the Kinect or lightfield cameras, light sensors, input sensors, etc. to generate environmentally aware lighting in the three-dimensional scene; determining a local environment condition such as temperature, weather, etc. of the user; etc.). In some variations, changes to the three-dimensional subject can be generated based on camera (or other image sensor) inputs such as the three-dimensional subject can look at the user, wave when the user waves, and/or can otherwise interact with and/or modify their interactions based on image-based inputs.

In some variations, surprises (e.g., easter eggs, novelties, unexpected responses, etc.) can be generated (in addition to and/or as the response). The surprises can be hardcoded (e.g., triggered based on trigger words or the context of a conversation) and/or soft coded (e.g., generated on-the-fly without preplanning such as from GPT models, by instructing the AI character to generate a list of possible surprises, and then create the instantiation of an object, or change to scene including both still images and videos). As an illustrative example, when the word carrot is mentioned, a three-dimensional carrot can appear in the 3D scene and a three-dimensional rabbit (e.g., the three-dimensional subject as shown in FIG. 2) can react. As a second illustrative example, a conversation with a three-dimensional subject can include a discussion of chemistry. Later in the conversation, the user can mention being sleepy (or other synonyms or related experiences), and the three-dimensional subject can generate a 3D model of the caffeine molecule.

In some variants, determining a response can include filtering the response such as to detect a potentially sensitive topic (e.g., upsetting, inappropriate such as for an age of a user, dangerous, classified, personal, private, obscene, profane, etc.). In these variants, the response can be filtered using a filter or model that is separate from (e.g., resides before) a language model used to determine a response, using a filter of the language model, and/or in any suitable manner.

In related variants, a response can be modified (e.g., depend on) whether a potentially sensitive topic is detected in the input. For instance, the response can deflect, redirect, be tangentially related to, directly confront (e.g., ‘we cannot discuss sensitive topics’), and/or can otherwise be modified based on a potentially sensitive topic in the input. As a concrete example, in a children's hospital setting a three-dimensional subject can be programmed to detect a question (or discussion) about death or life span of a child and redirect the conversation to tell a story to the user(s) rather than answer the question directly.

In some variants, a plurality of responses can be determined. In these variants, preferably only one response is performed (e.g., in S300). The response can be selected according to a metric (e.g., the first response to be completed, the shortest response, based on a readability of the response, based on a comprehensibility of the response, etc.), using machine learning, using voting, and/or can otherwise be selected. As an illustrative example, when a first model takes greater than a threshold response time to generate a response a prompt (e.g., the historical conversation record, the current user responses, etc.) can be sent to a second model where which model generates a result first can be used to produce the response. However, any suitable responses can be performed.

Performing the response S300 functions to modify the three-dimensional subject and/or output the response. For example, the audio can be played for an audio response from the three-dimensional subject to continue a conversation with the user. In another example, the three-dimensional subject and/or scene associated therewith can be changed based on the response. In another example, changes can be made in the environment of the user. However, any suitable response(s) can be performed digitally and/or in the real world.

The response can be performed after the full response is determined, as the response is determined (e.g., each word or phrase can be spoken as the language model generates it, streaming the textual response from the LLM, etc. which can be particularly beneficial for minimizing a latency in the response and breaking immersion for the viewer), after a subset of the response is determined (e.g., after a threshold amount of a response such that the remainder of the response is expected to be determined without a pause in speech resulting from the response determination-a pause could still be included based on a personality of the three-dimensional subject, for dramatic effect, for emphasis, etc.), a delay after the response is determined (e.g., a broadcast delay such as to detect a potentially sensitive topic), and/or with any suitable timing. In some variations, particularly when a delay exceeds a threshold delay, a preliminary response can be performed that includes a pause, change in 3D image expression, a comment about the delay (e.g., ‘I'll need to think about that one for a moment’), and/or otherwise addresses what could otherwise result in immersion breaking latency. However, any suitable processes or solutions can be used to address latency.

Performing the response typically includes performing speech synthesis to convert the response from text to a waveform (where the waveform can be output from a speaker). The speech synthesis can be accomplished using concatenative synthesis (e.g., unit selection synthesis, diphone synthesis, domain-specific synthesis, etc.), formant synthesis, articulatory synthesis, HMM (e.g., hidden Markov model) synthesis, sinewave synthesis, deep learning-based synthesis, artificial intelligence (e.g., a generative voice model), voice cloning, and/or any suitable synthesis method(s) can be used. In some variants, the speech synthesis can include modulating the waveform based on the three-dimensional subject (e.g., an age, gender, dialect, personality, origin, language, emotional state, sentiment, relationship to the user, etc.). Qualities of the speech (e.g., tone, volume, inflection, pitch, accent, etc.) can be generated (e.g., by a generative sounds AI), accessed from sound clips, be synthetic sounds (e.g., combinations of sine and cosine waves), be taken from a sound library, and/or can otherwise be generated and/or determined.

As latency greater than a threshold time (e.g., 1 second, 2 seconds, 5 seconds, 10 seconds, 20 seconds, 30 seconds, 60 seconds, etc.) can interrupt the flow of a conversation between a user and 3D subject, variants of determining the response can handle the latency in a variety of manners. In some variants, the response can be generated on a local computing system (e.g., local to the display, connected to the display(s) with a direct wired connection, etc.) to reduce the latency. In other variants, the use of a cloud computing system (particularly but not exclusively a cloud computing server located in a region proximal the user) to determine the response can be advantageous for reducing a local power, computing bandwidth, and/or other aspects of the local computing hardware which can reduce a latency and/or facilitate the use of more complex model to generate the response. In other variants, the response can be parsed into smaller or simpler segments (e.g., phonemes, words, sentences, paragraphs, etc. such as packetizing the response), where the segments can be provided (e.g., in S300) as they are detected (e.g., rather than generating the full response). For example, once a first sentence has been generated (and identified), the 3D subject can begin speaking the first sentence while the rest of the response is generated (e.g., in S200) and subsequently presented. However, additionally or alternatively, the 3D subject can be configured to use filler words or phrases (e.g., ‘uh,’ ‘um,’ etc.), tell monologues (e.g., hardcodes monologues), extend sounds (e.g., stretch out sounds), become distracted (e.g., have an animation of a phone ringing to imitate a call for the 3D subject, zones out, pretends to observe something in the room, etc.), and/or can otherwise fill or appear to fill a void (e.g., in a manner that can be determined based on a personality associated with the 3D subject) while the response is generated. In another variant, a subset of responses (e.g., responses to common inputs such as greetings, small talk, closings, etc.) can be hardcoded or pregenerated (e.g., rather than requiring a response to be generated using a language model).

In some variants, the 3D subject can perform an action before a response has been determined and/or while the response is being determined. For example, the 3D subject can change pose (e.g., ears pop up to indicate listening, enters a thinking pose to indicating that it is determining how to respond, etc.) before providing a response. Similarly, once the response is determined the 3D subject can make a physical indication that they have determined their response, mime out the response (e.g., produce mouth movements such as to match the sounds of the words they are saying, to look like it is talking, etc.; make facial expressions or body language matching the tone of the response, based on the response content, etc.; etc.), and/or can otherwise perform action(s) while providing the response(s). These actions are typically generated and/or determined by a separate model (e.g., a model that processes the response text) from a language model used to generate the response. As another example, a 3D subject can initiate the method and/or steps thereof (e.g., a conversation) such as by asking a question, making a statement (e.g., based on the 3D subject, based on a context such as location of the 3D subject, etc.), introducing itself, telling a joke, and/or in any manner. The initiation from the 3D subject can be hardcoded, generated (e.g., using a language model such as using non-audio inputs), and/or can otherwise be determined. However, the actions can be generated and/or determined by the language model.

In some variants, performing the response can include parsing the response to determine how to perform the response. For example, the response can be parsed to determine what from the response should be said by the 3D subject, what action(s) the 3D subject should perform, what additional content should be displayed, and/or other suitable actions. Typically, the response is parsed based on key words and/or phrases (or derivatives thereof) within the response. However, the response can additionally or alternatively be parsed using machine learning and/or in any manner.

Performing the response can include determining a direction to one or more users and presenting the response (e.g., directing audio toward) in the direction of the one or more speakers (e.g., by using a phased speaker, speaker array, rearranging speakers, etc.).

In some variants that include determining a direction to the one or more users (also referred to as viewers as viewers do not necessarily have to look at the display to interact with the 3D image) can include determining an eye pose for each eye of the user and modifying the eye direction (e.g., pupil direction, iris direction, etc.) of the 3D subject based on the eye direction of the user(s). As a first example, the 3D subject's eye pose can be modified to make eye contact to facilitate capturing or maintaining the attention of the user(s) to the conversation and/or based on a personality of the 3D subject (e.g., a dominant, aggressive, assertive, etc. personality). As a second example, the 3D subject's eye pose can match an eye pose of the user(s) such that the 3D subject appears to be looking at the same thing(s) and/or direction as the user(s), where one or more optical sensors (e.g., cameras, thermal cameras, etc.) can be used to enable the 3D subject to perceive objects in that direction and converse about them. As a third example, the 3D subject's eye pose can be modified to reduce or remove eye contact from a user (e.g., because the 3D subject is showing contrition, sadness, meekness, shyness, or other personality traits). However, a response can otherwise be prepared in response to the eye pose (e.g., eye tracking) information (e.g., to detect when a user is losing interest in the conversation, the 3D subject can offer a closing or try changing the subject).

In some variants, generating and/or performing the response can include gathering analytics about engagement with the 3D subject (e.g., conversation topics, conversation duration, conversation language, surprises uncovered, 3D subject personality, user personality, etc.). Those analytics can be used (e.g., as training data) to change behavior of the 3D subject and/or interactions (e.g., the generated responses). As an illustrative example, the training data could be used to improve the ability of the 3D subject to speak a particular language (e.g., increase vocabulary, increase sentence complexity, form more complex sentences, etc.). In related variants, the response(s) and/or intermittent steps to forming the response can be logged (e.g., stored), for example to develop greater understanding of (e.g., additional training data) for a creative process (e.g., formation of images, text, videos, models, games, etc.).

In variants where the response includes a game, the 3D subject can form or create a game (e.g., known games such as pong, checkers, tic-tac-toe, chess, etc.; an unknown game such as with new rules or conditions by combining or generating a game, tailored to one or more users, etc.; etc. such as by writing code to perform the game, finding a web-based, application-based, etc. implementation of the game, etc.) and/or can play the game with the user(s).

In some variants, the 3D subject and/or interacting with the 3D subject can be recombinant. For instance, the 3D subject can create code or change operation instructions or process involved in the determination of and/or presentation of responses. The recombination can be performed in real-time (e.g., during a conversation with one or more users) and/or with a delay (e.g., training after a conversation or set of conversations are concluded).

In an illustrative example, interacting with a three-dimensional subject can include receiving a voice request, converting the voice request to text, providing the text to a generative language model (e.g., ChatGPT, LaMDA, LLAMA, Character.ai, SearchGPT, YaLM, SageMaker, Wenxin Yiyan, etc.) to generate response to the voice request, optionally (e.g., a trigger word is detected, based on the conversation, etc.) generating one or more surprise responses, and performing or outputting the response(s) (e.g., playing audio). In variations, one or more image input can be received where the response(s) can depend on the image input. However, a three-dimensional subject can be interacted with in any manner.

In a second illustrative example of using or interacting with a three-dimensional subject, the three-dimensional subject can be located in a hotel (or motel, homestay, bed-and-breakfast, etc.) room (e.g., can act in a capacity similar to a concierge). In this example, the three-dimensional subject can provide information for the user(s) (e.g., guests) about amenities; how to operate and/or use appliances, plumbing fixtures, etc. in the room; local attractions; deals; and/or any suitable information. Relatedly, the three-dimensional subject can provide companionship (e.g., a conversation partner) for one or more users, book activities at the request of the user(s) (e.g., restaurant reservations, attraction entrance time, etc. such as by calling, messaging, etc. the activity). In some variations of this example, the information provided by the three-dimensional subject can be changed based on external data (e.g., occupation percentage, number of guests, etc. can be used to inform potential deals shared with the user(s); real-time use or map data can be used to inform recommendations for local attractions; etc.). In related variations, the three-dimensional subject can act as an assistant (e.g., scheduling assistant) to facilitate scheduling meetings, appointments, etc. for one or more users (e.g., where the 3D subject can access a calendar of the user and book time; respect user preferences such as for focus time, batching meetings, meeting durations, meeting times within a day, etc.; etc.). Similarly, the 3D subject can remind the user(s) of upcoming calendar events (e.g., appointments; meetings: special occasions such as holidays, birthdays, anniversaries, etc.; etc. such as providing a spontaneous statement of or conversation about upcoming calendar events in the context of the personality of that 3D subject).

In a third illustrative example of using or interacting with a three-dimensional subject, the 3D subject can be a conversation partner within a children's hospital. In these examples, the 3D subject can act as a partner, comforting presence, confidant, and/or other presence to one or more child or family member at the hospital. In this example, there can be many potentially sensitive topics that come up in conversation. The 3D subject can be configured to determine responses that are appropriate for the user(s) (e.g., age, religion, medical condition, preferences, etc.). For instance, a potentially challenging topic that can arise in such a situation is a conversation about death. Instead of providing a response that tells a harsh or scary reality (e.g., ‘you may die as a result of your illness’ in response to an input such as ‘how long do I have to live’), the 3D subject can be configured to detect the potentially stressful conversation topic and produce a response that is tangentially related to the topic (e.g., telling a story such as about how much the user's family loves them) rather than directly addressing the input. However, when the user is insistent (e.g., repeats the input or variants of it a threshold number of times), the 3D subject can be configured to deliver a gentle answer to the question (e.g., rather than a medically correct answer such as ‘nobody knows when we will die’ rather than ‘about 90% of people with your condition die within 3 months of receiving the diagnosis’). Related variations can be used in any situation that potentially sensitive information arises. For instance, when a user provides sensitive or classified information (e.g., social security number, bank accounts, etc.) the 3D subject can be configured to indicate that they should not (and why) provide that information. In some variations of this illustrative example, a caregiver, health care provider, and/or other individuals can be alerted (e.g., via text message, application alert, e-mail, etc.) to the potentially sensitive topic so that the individual(s) can step in to discuss the potentially sensitive topic.

In a fourth illustrative example of using or interacting with a three-dimensional subject (as shown for example in FIG. 6), the 3D subject can be configured to generate a response (e.g., initiate a conversation, express a declarative statement, etc.) when one or more user(s) are idle (e.g., have not interacted with the 3D subject in a threshold amount of time). For example, the 3D subject can encourage a nearby user to stand-up and move around, meditate, change what they are doing, inquire as to how the user(s) are doing, and/or can otherwise act. In some variations of this example, the 3D subject can be used to fill an office space (e.g., make an office space or remote office space feel as though there are more coworkers or a higher concentration of coworkers). To further this illusion, during the idling time (e.g., when conversation is not occurring), the 3D subject can include a three-dimensional desk, computer, phone, and/or other working implements and can mimic working postures and/or gestures (e.g., taking a phone call, typing on a keyboard, reading on a screen, etc.).

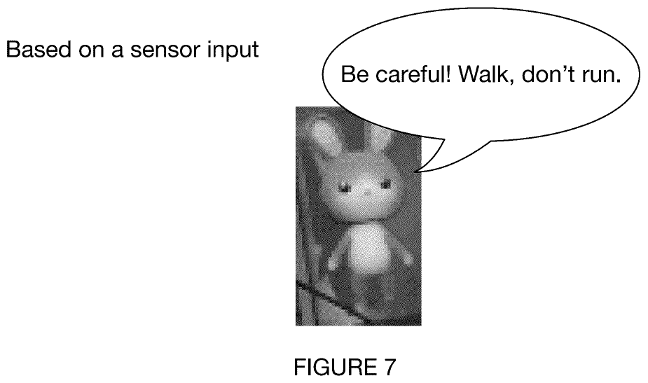

In a fifth illustrative example of using or interacting with a three-dimensional subject (as shown for example in FIG. 7), the 3D subject can be configured to receive (e.g., a response can be generated based on) sensor data. In a concrete example, a sensor can be used to detect that a user is running (e.g., in a location where it may not be safe to run such as a pool) and the 3D subject can produce an output based on that sensor information (e.g., ‘stop running!’).

In a sixth illustrative example of using or interacting with a three-dimensional subject (as shown for instance in FIG. 4), the 3D subject can be associated with one or more additional displays. The 3D subject can produce a conversation while using the additional displays to present information concurrently with the conversation. For instance, the 3D subject can use the additional displays to present directions (e.g., a map, timetable, etc.), an advertisement (e.g., deals, new restaurants, new attractions, related items or objects that the user might be interested in, etc.), education (e.g., factual information, correction to information provided by the user(s), etc.), creative outputs (e.g., an image, model, character, avatar, object, etc. created through a conversation between a user and the 3D subject), and/or can be used in any manner.

In a seventh illustrative example or using or interacting with a three-dimensional subject, a conversation with the three-dimensional subject can be used to create a character or avatar. For instance, sliders or selections can be provided as inputs (e.g., be verbally provided) where the three-dimensional subject can adjust the character (including potentially the three-dimensional subject itself) based on those inputs. In this example, the character could be created using an image generative AI, a 3D generative AI, a character creator, and/or any suitable method(s). The character can be displayed on the same display as the three-dimensional subject conversing with the user, in place of the three-dimensional subject (e.g., the three-dimensional subject maintains the conversation but is not presented in the display), in a separate display from the three-dimensional subject, not be displayed, and/or can be displayed in any manner.

In an eighth illustrative example, a system can comprising a three-dimensional display configured to project light that is perceivable as a three-dimensional image, a microphone configured to receive an input audio signal, a speaker configured to output an output audio signal, and a processor configured to: convert the input audio signal into a text; determine a response to the text using a large language model (LLM), wherein the output audio signal comprises the response; and modify the three-dimensional image based on at least one of the input audio signal and the response. In variations of the eighth illustrative example or variations thereof the three-dimensional image can comprise a character, wherein the character is associated with a personality. In other variations of the eighth illustrative example or variations thereof the three-dimensional image can comprise a photorealistic representation of a person. In variations of the eighth illustrative example or variations thereof the processor can be further configured to generate the response based on the personality of the character. In variations of the eighth illustrative example or variations thereof modifying the three-dimensional image can comprise modifying the character to an appearance associated with a delay when determining a response requires greater than a threshold time. In variations of the eighth illustrative example or variations thereof when the delay exceeds the threshold time the processor is further configured to provide the test to a second LLM to determine a second response, wherein the response comprises the first completed of the response determined by the LLM and the second response. In variations of the eighth illustrative example or variations thereof, the system can further comprise an eye tracker configured to determine an eye pose of a viewer of the display, wherein modifying the three-dimensional image comprises changing an eye-direction of the character to match the eye pose of the viewer. In variations of the eighth illustrative example or variations thereof the processor is further configured to generate a second output audio signal without receiving an input audio signal. In variations of the eighth illustrative example or variations thereof the processor is further configured to store a historical record of prior input audio signals and prior responses, wherein the LLM determines the response based on the historical record and the text, wherein the text is added to the historical record before an earliest record in the historical record. In variations of the eighth illustrative example or variations thereof after the response is generated, the text added to the historical record before the earliest record in the historical record is removed. In variations of the eighth illustrative example or variations thereof the display comprises an autostereoscopic display configured to output a plurality of images comprising different perspectives of a common subject in the three-dimensional image, wherein each image of the plurality of images is output in a different viewing direction. In variations of the eighth illustrative example or variations thereof the autostereoscopic display comprises: a screen configured to output the light, a lenticular array overlaid on the screen, wherein the lenticular array is oriented at an angle relative to pixels of the screen, and wherein the processor is further configured to generate a lightfield image comprising the common subject by assigning pixels of the screen to pixels of the image based on the different viewing directions and the angle.

In a ninth illustrative example, a method can comprise receiving a three-dimensional subject, displaying the three-dimensional subject using a display, receiving input audio, outputting a response to the input audio, wherein the response is generated using a large language model (LLM), modifying an appearance of the three-dimensional subject based on the input audio, and concurrently with outputting the response, changing the displayed three-dimensional subject to the modified appearance of the three-dimensional subject. In variations of the ninth illustrative example or variations thereof receiving the three-dimensional subject can comprise generating the three-dimensional subject using a text-to-image artificial intelligence model based on a description for a three-dimensional subject. In variations of the ninth illustrative example or variations thereof modifying the appearance can comprise detecting a trigger word or phrase in the input audio and adding a secret based on the trigger word or phrase. In variations of the ninth illustrative example or variations thereof the response is further generated based on a historical record of prior input audio and prior responses. In variations of the ninth illustrative example or variations thereof the input audio is added to the historical record before an earliest entry in the historical record, wherein the LLM receives the historical record and generates the response based on the historical record, wherein after the response is generated the input audio is removed from before the earliest entry in the historical record. In variations of the ninth illustrative example or variations thereof when a time to generate the response exceeds a threshold delay, the method further comprises providing the historical record to a second LLM to generate a second response, wherein outputting the response comprises outputting the response of the second response based on which of the response or the second response is generated first. In variations of the ninth illustrative example or variations thereof wherein the three-dimensional subject is associated with a personality, wherein the response is further generated based on the personality. In variations of the ninth illustrative example or variations thereof audio characteristics of the output audio can depend on the personality. In variations of the ninth illustrative example or variations thereof the method can further comprise tracking an eye pose of a viewer of the display, wherein modifying an appearance of the three-dimensional subject comprises modifying an eye direction of the three-dimensional subject to match the eye pose of the viewer.

The methods of the preferred embodiment and variations thereof can be embodied and/or implemented at least in part as a machine configured to receive a computer-readable medium storing computer-readable instructions. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A system comprising:
a three-dimensional display configured to project light that is perceivable as a three-dimensional image;
a microphone configured to receive an input audio signal;
a speaker configured to output an output audio signal; and
a processor configured to:
convert the input audio signal into a text;
determine a response to the text using a large language model (LLM), wherein the output audio signal comprises the response; and
modify the three-dimensional image based on at least one of the input audio signal and the response.

2. The system of claim 1, wherein the three-dimensional image comprises a character, wherein the character is associated with a personality.

3. The system of claim 2, wherein the processor is further configured to generate the response based on the personality of the character.

4. The system of claim 2, wherein modifying the three-dimensional image comprises modifying the character to an appearance associated with a delay when determining a response requires greater than a threshold time.

5. The system of claim 4, wherein the delay exceeds the threshold time the processor is further configured to provide the test to a second LLM to determine a second response, wherein the response comprises the first completed of the response determined by the LLM and the second response.

6. The system of claim 2, further comprising an eye tracker configured to determine an eye pose of a viewer of the display, wherein modifying the three-dimensional image comprises changing an eye-direction of the character to match the eye pose of the viewer.

7. The system of claim 1, wherein the processor is further configured to generate a second output audio signal without receiving an input audio signal.

8. The system of claim 1, wherein the processor is further configured to store a historical record of prior input audio signals and prior responses, wherein the LLM determines the response based on the historical record and the text, wherein the text is added to the historical record before an earliest record in the historical record.

9. The system of claim 8, wherein after the response is generated, the text added to the historical record before the earliest record in the historical record is removed.

10. The system of claim 1, wherein the display comprises an autostereoscopic display configured to output a plurality of images comprising different perspectives of a common subject in the three-dimensional image, wherein each image of the plurality of images is output in a different viewing direction.

11. The system of claim 10, wherein the autostereoscopic display comprises:
a screen configured to output the light;
a lenticular array overlaid on the screen, wherein the lenticular array is oriented at an angle relative to pixels of the screen; and
wherein the processor is further configured to generate a lightfield image comprising the common subject by assigning pixels of the screen to pixels of the image based on the different viewing directions and the angle.

12. A method comprising:
receiving a three-dimensional subject;
displaying the three-dimensional subject using a display;
receiving input audio;
outputting a response to the input audio, wherein the response is generated using a large language model (LLM);
modifying an appearance of the three-dimensional subject based on the input audio; and
concurrently with outputting the response, changing the displayed three-dimensional subject to the modified appearance of the three-dimensional subject.

13. The method of claim 12, wherein receiving the three-dimensional subject comprises generating the three-dimensional subject using a text-to-image artificial intelligence model based on a description for a three-dimensional subject.

14. The method of claim 12, wherein modifying the appearance comprises:
detecting a trigger word or phrase in the input audio; and
adding a secret based on the trigger word or phrase.

15. The method of claim 12, wherein the response is further generated based on a historical record of prior input audio and prior responses.

16. The method of claim 15, wherein the input audio is added to the historical record before an earliest entry in the historical record, wherein the LLM receives the historical record and generates the response based on the historical record, wherein after the response is generated the input audio is removed from before the earliest entry in the historical record.

17. The method of claim 15, wherein when a time to generate the response exceeds a threshold delay, the method further comprises providing the historical record to a second LLM to generate a second response,
wherein outputting the response comprises outputting the response of the second response based on which of the response or the second response is generated first.

18. The method of claim 12, wherein the three-dimensional subject is associated with a personality, wherein the response is further generated based on the personality.

19. The method of claim 18, wherein audio characteristics of the output audio depend on the personality.

20. The method of claim 12, further comprising tracking an eye pose of a viewer of the display, wherein modifying an appearance of the three-dimensional subject comprises modifying an eye direction of the three-dimensional subject to match the eye pose of the viewer.
